(19) United States
(12) Patent Application Publication
(10) Pub. No.: US 2018/0101639 A1
(43) Pub. Date: Apr. 12, 2018

(54) SYSTEMS AND METHODS FOR PREDICTIVE EVENTS OF TURBOMACHINERY

(71) Applicant: General Electric Company, Schenectady, NY (US)

(72) Inventors: Subrat Nanda, Katy, TX (US); William Randolph Shinkle, Cincinnati, OH (US)

(21) Appl. No.: 15/289,812

(22) Filed: Oct. 10, 2016

(51) Int. Cl. G06F 17/50; G06N 5/02

(52) U.S. Cl. CPC G06F 17/5086; G06N 5/022

(57) ABSTRACT

In one embodiment, a processor is configured to execute the instructions to receive a first data comprising sensed operations for one or more turbine systems in a fleet of turbine systems. The sensed operations are sensed via a plurality of sensors disposed in the one or more turbine systems. The processor is also configured to execute the instructions to extract a second data comprising a plurality of events included in a turbine controller event log, to derive at least one sensor model based on the first data, to derive at least one association rule based on the first data, the second data, or a combination thereof, to execute the instructions to derive a combination model by combining the at least one sensor model and the at least one association rule.

### BACKGROUND OF THE INVENTION

The subject matter disclosed herein relates to turbomachinery, and more specifically, to systems and methods for predictive events of the turbomachinery.

Certain turbomachinery, such as turbine systems create power (e.g., mechanical power) and may include many components, such as turbine blades, sensors, generators, and so on that operate for long periods of time. These components may wear, experience undesired maintenance events, or operate inefficiently over time. Therefore, the turbine system may be taken offline to repair or replace certain equipment. The turbine system may be shut down, or not generating electricity or energy, when a component of the turbine system must be repaired or replaced. There is a desire, therefore, for systems and methods that enhance turbomachinery life, for example, via predictive events.

### BRIEF DESCRIPTION OF THE INVENTION

In one embodiment, a turbine system includes a memory configured to store instructions and a processor configured to execute the instructions to receive a first data comprising sensed operations for one or more turbine systems in a fleet of turbine systems. The sensed operations are sensed via a plurality of sensors disposed in the one or more turbine systems. The processor is also configured to execute the instructions to extract a second data comprising a plurality of events included in a turbomachinery controller event log, to derive at least one sensor model based on the first data, and to derive at least one association rule based on the first data, the second data, or a combination thereof. Additionally, the processor is configured to execute the instructions to derive a combination model by combining the at least one sensor model and the at least one association rule.

In a second embodiment, a method includes receiving, via a processor, a first data comprising sensed operations for one or more turbine systems in a fleet of turbine systems. The sensed operations are sensed via a plurality of sensors disposed in the one or more turbine systems. The method includes extracting, via the processor, a second data comprising a plurality of events included in a turbomachinery controller event log, deriving, via the processor, at least one sensor model based on the first data, and deriving, via the processor, at least one association rule based on the first data, the second data, or a combination thereof. The method further includes deriving, via the processor, a combination model by combining the at least one sensor model and the at least one association rule.

In a third embodiment, a tangible, non-transitory computer-readable media storing computer instructions thereon is provided. The computer instructions, when executed by a processor, cause the processor to receive a first data comprising sensed operations for one or more turbine systems in a fleet of turbine systems. The sensed operations are sensed via a plurality of sensors disposed in the one or more turbine systems. The computer instructions also cause to processor to extract a second data comprising a plurality of events included in a turbomachinery controller event log, to derive at least one sensor model based on the first data, and to derive at least one association rule based on the first data, the second data, or a combination thereof. The computer instructions further cause the processor to derive a combination model by combining the at least one sensor model and the at least one association rule.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of a power generation system;

FIG. 2 is a schematic block diagram illustrating an embodiment of an analytics center interacting with a fleet of turbine systems;

FIG. 3 is an embodiment of a process suitable for deriving a combination model inside the analytics center of FIG. 2; and

FIG. 4 is an embodiment of a process suitable for applying the combination model derived via the process of FIG. 3 to derive predicted events of turbine components.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

When turbomachinery components, such as gas turbine system components, experience undesired maintenance events, an entire gas turbine system may be taken offline. Such a shutdown negatively affects the gas turbine system operation. For example, when a turbine blade cracks or a sensor malfunctions, the efficiency of the entire gas turbine system will likely go down, and the turbine blade and/or sensor is likely to be repaired or replaced. Before the techniques described herein, the efficiency savings of scheduling multiple equipment replacements or repairs may not have been predicted for gas turbine systems. The techniques described herein enable derivation of combination models that combine sensor data and control data such that the combination models are suitable for predicting or forecasting when equipment will experience undesired maintenance, work stoppage conditions, or other events related to the gas turbine system. The models may also estimate the respective accuracy of each prediction. With the predictions and the accuracy of the predictions, operators may improve scheduling services to the gas turbine system to reduce downtime and improve gas turbine system operations.

The techniques described herein provide for a modeling methodology to derive predicted events for gas turbine systems. The predictive events can be utilized to schedule downtime or to prepare for upcoming predicted process upsets. In one embodiment, a process for modeling may be summarized as follows. First, an analytics center receives data from sensors disposed in one or more gas turbine systems and extracts control data from one or more controllers of the gas turbine systems. The sensor data may be collected at a first time frame while the control data (e.g., controller events data) may be collected at a second time frame different from the first time frame. For example, the first time frame may be measures in seconds, minutes, and/or hours, while the second time frame may be measures in microseconds, milliseconds, and/or seconds. Likewise, the sensor data may be compressed to save space and improve transmission time, thus lowering the sensor data time resolution compared to the control data time resolution. The use of the control data in conjunction with the sensor data may improve predictive accuracy and may alleviate any compression losses in the sensor data. The analytics center may filter and remove nonsensical or outlier data before or after the data is mined. Further, the analytics center may mine the data, either before combining the data, after combing the data, or both before and again after mining the data, to create sensor models and association rules. The sensor models may define probability assessments of whether an anomaly has occurred in the data. The association rules relate control events or categories of events to patterns in the data. The analytics center then combines the sensor models and association rules to derive combination model(s).

Once the combination model(s) are created, they may be used to derive predictive events for gas turbine systems as well as a probability accuracy of the events occurring. The combination model(s) may recognize sequences of live data that are similar to sequences of historical data. More particularly, if the sequence of historical data was often followed by a distinct occurrence in the gas turbine system, the combination model(s) may be capable of identifying the sequence or similar sequences in live data. Further, the combination model(s) may derive the predictive event based on the distinct occurrence and an estimate of how likely it is that the predictive event will follow. The analytics center may then communicate with the controller or (Human Machine Interface) HMI of the gas turbine system so that plant operators (or the gas turbine controller) may schedule downtime and/or implement process changes to minimize the effects of undesired predictive events. Likewise, the gas turbine controller may issue alarms/alerts or take certain control actions to minimize the effects of the undesired predictive events.

The combination model(s) may be created and trained from historical data from gas turbine systems or other turbomachinery. Indeed, the techniques described herein may be used with other turbomachinery such as steam turbines, wind turbines, hydroturbines, turboexpanders, and the like. The combination model(s) may be more accurate if trained with larger quantities of data or with data specifically from the turbomachinery (e.g., gas turbine system) for which the predictive events are derived. In exemplary embodiments, each of the combination models continues to train itself while operating on live data, thus evolving according to feedback in order to provide more accurate predictive events.

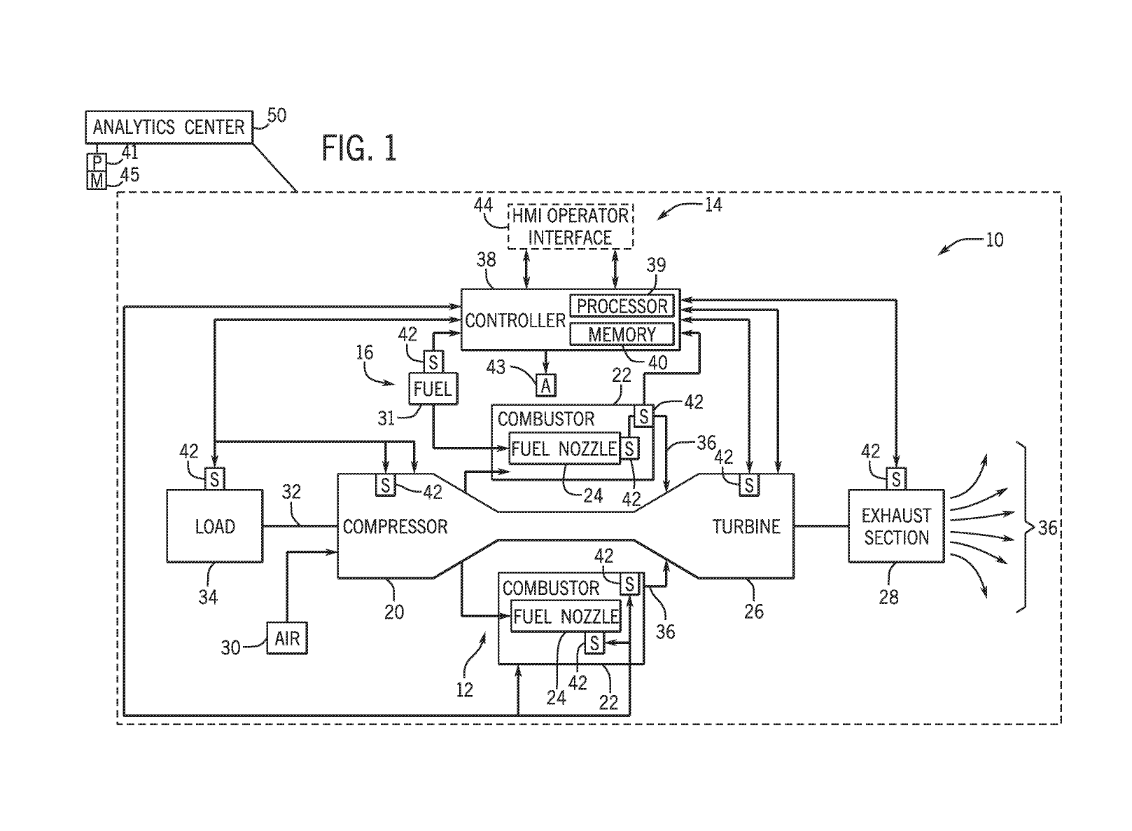

It may be useful to describe a turbomachinery system incorporating the techniques described herein. Accordingly, and turning now to FIG. 1, the figure is a schematic diagram illustrating an industrial system 10, such as a power plant, that includes a turbomachinery, such as a gas turbine system 12 operatively connected a monitoring and control system 14 and fluidly connected to a fuel supply system 16. The gas turbine engine or system 12 may include a compressor 20, combustion systems 22, fuel nozzles 24, a gas turbine 26, and an exhaust section 28. During operation, the gas turbine system 12 may pull an oxidant such as air 30 into the compressor 20, which may then compress the air 30 and move the air 30 to the combustion system 22 (e.g., which may include a number of combustors). The air 30 may encounter an inlet guide vane system 33 having vanes that may be positioned at a variety of angles to optimize intake of the air 30 and operations of the gas turbine system 12.

In the combustion system 22, the fuel nozzle 24 (or a number of fuel nozzles 24) may inject fuel that mixes with the compressed air 30 to create, for example, an air-fuel mixture. The air-fuel mixture may combust in the combustion system 22 to generate hot combustion gases, which flow downstream into the turbine 26 to drive one or more turbine stages. For example, the combustion gases may move through the turbine 26 to drive one or more stages of turbine blades, which may in turn drive rotation of a shaft 32. The shaft 32 may connect to a load 34, such as a generator that uses the torque of the shaft 32 to produce electricity. After passing through the turbine 26, the hot combustion gases may vent as exhaust gases 36 into the environment by way of the exhaust section 28. The exhaust gas 36 may include gases such as carbon dioxide (CO₂), carbon monoxide (CO), nitrogen oxides (NOₓ), and so forth.

In certain embodiments, the system 10 may also include a controller 38. The controller 38 may be communicatively coupled to a number of sensors 42, a human machine interface (HMI) 44, and one or more actuators 43 suitable for controlling components of the system 10. The actuators 43 may include valves, switches, positioners, pumps, and the like, suitable for controlling the various components of the system 10. The controller 38 may receive data from the sensors 42, and may be used to control the compressor 20, the combustors 22, the turbine 26, the exhaust section 28, the load 34, and so forth.

In certain embodiments, the HMI 44 may be executable by one or more computer systems of the system 10. A plant operator may interface with the industrial system 10 via the HMI 44. Accordingly, the HMI 44 may include various input and output devices (e.g., mouse, keyboard, monitor, touch screen, or other suitable input and/or output device) such that the plant operator may provide commands (e.g., control and/or operational commands) to the controller 38. Further, operational information from the controller 38 and/or the sensors 42 may be presented via the HMI 44. Similarly, the controller 38 may be responsible for controlling one or more final control elements coupled to the components (e.g., the compressor 20, the turbine 26, the combustors 22, the load 34, and so forth) of the industrial system 10 such as, for example, one or more actuators, valves, transducers, and so forth.

In certain embodiments, the sensors 42 may be any of various sensors useful in providing various operational data to the controller 38. For example, the sensors 42 may provide pressure and temperature of the compressor 20, speed and temperature of the turbine 26, vibration of the compressor 20 and the turbine 26, CO₂ levels in the exhaust gas 36, carbon content in the fuel 31, temperature of the fuel 31, temperature, pressure, clearance of the compressor 20 and the turbine 26 (e.g., distance between the compressor 20 and the turbine 26 and/or between other stationary and/or rotating components that may be included within the industrial system 10), flame temperature or intensity, vibration, combustion dynamics (e.g., fluctuations in pressure, flame intensity, and so forth), load data from load 34, output power from the turbine 26, and so forth.

The controller 38 may include a processor(s) 39 (e.g., a microprocessor(s)) that may execute software programs to perform the disclosed techniques. Moreover, the processor 39 may include multiple microprocessors, one or more “general-purpose” microprocessors, one or more special-purpose microprocessors, and/or one or more application specific integrated circuits (ASICS), or some combination thereof. For example, the processor 39 may include one or more reduced instruction set (RISC) processors. The controller 38 may include a memory device 40 that may store information such as control software, look up tables, configuration data, etc. The memory device 40 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof). The memory device 40 may store a variety of information, which may be suitable for various purposes. For example, the memory device 40 may store machine-readable and/or processor-executable instructions (e.g., firmware or software) for the processor 39 execution.

In certain embodiments, the system 10 may also be communicatively coupled to an analytics center 50. The analytics center 50 may include a processor(s) 41 and a memory device 45 respectively similar to the processor 39 and memory device disclosed above. In one embodiment, the memory device 45 also may store instructions, that when executed, cause the processor 41 to create one or more combination models for use in deriving predictive events for turbomachinery. By deriving the combination model which may then be used to predict when turbomachinery or turbomachinery components are likely candidates for repair or replacement, the techniques described herein provide for improved maintenance and downtime operations as well as more efficient resource use for the power production system 10. The analytics center 50 may create the combination model by first processing and/or collecting data from the sensors 42 and/or data from the control system 16. In one embodiment, the control system data may include controller event log(s) data, detailing a series of events derived by the controller and/or events that occurred inside the gas turbine system 12 and/or events related to the gas turbine system 12. In one embodiment, the controller 38 is a Mark VIe distributed control system (DCS) available from General Electric Co., of Schenectady, N.Y., USA. The controller 38 may include a triple modular redundant controller having at least three cores (e.g., R, S, T cores) that may “vote” to provide for redundant operations of the controller 38.

As further described below, the analytics center 50 uses the data (e.g., sensor data, controller data) to create one or more predictive, combination models suitable for predicting component issues and/or failures of the gas turbine system 12, as well as an accuracy probability for the prediction. The model creation and use may be performed in the analytics center 50 at a geographically remote location to the turbine system 12, but may also or instead be performed locally in the controller 38 and/or external computing systems, such as a workstation computer, laptop, notebook, and/or other computing systems having processors and memories of the turbine system 12.

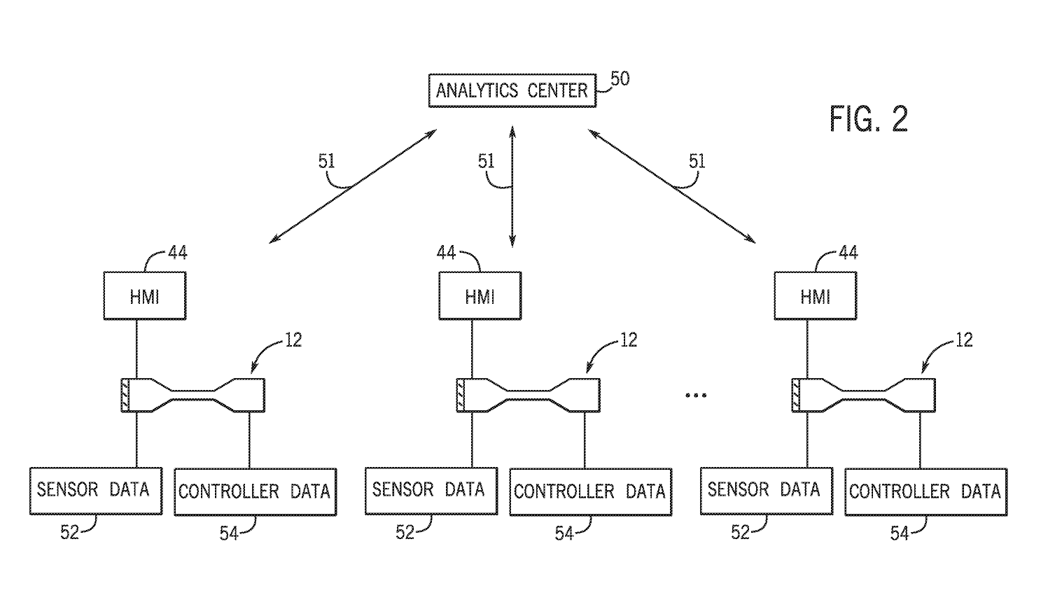

FIG. 2 is a schematic block diagram illustrating the analytics center 50 interacting with a fleet of gas turbine systems 12. For example, the same or similar model numbers for the gas turbine system or engine 12 may be communicatively grouped together and data may be obtained for the group. In one non-limiting example, the gas turbine system 12 model may be a LM6000 gas turbine system available from General Electric Co. of Schenectady, N.Y. Accordingly, data for certain (or all) operational LM6000 gas turbines 12 may be collected. In the illustrated embodiment, the analytics center 50 is at the geographically remote location and receives sensor data 52 and extracts control data 54 from each gas turbine system 12 of a fleet of gas turbine systems 12 via communication conduits 51. The communication conduits 51 may include wired conduits and/or wireless conduits (e.g., Wi-Fi, Bluetooth, ZigBee, Cloud-based conduits). In other embodiments, the analytics center 50 may only interact with one gas turbine system 12, and/or the analytics center 50 may be communicatively coupled to the controller 38 of a gas turbine system 12 directly.

In the depicted embodiment, the analytics center 50 is configured to communicate with and collect data from each gas turbine system 12. The sensor data 52 may include a detailed log of operations data, such as power produced by the power production system 10, fuel type data, fuel flow data, other flow data (e.g., air flow), temperatures, pressures, clearances (e.g., distances between a stationary and a rotating component), speed, velocity, inlet guide vane (IGV) 33 position, IGV system 33 loss, exhaust system 28 loss, auxiliary loads, and so on. Sensor data 52 may also include ambient conditions (e.g., temperature, humidity, atmospheric pressure). The sensor data 52 may be collected and transmitted to the analytics center 50 via the communication conduits 51 at a first time frame or constant rate, for example, one data point per millisecond, second, minute, hour. This rate may be referred to as a first time resolution. Additionally, the sensor data 52 may be reduced and/or compressed. For example, rather than transmitting every data point collected, the techniques described herein may transmit the first out of every hundred data points and discard the remaining ninety nine, or may transmit an average for each ten data points, or may transmit only the first data point of multiple data points with the same value, and/or by applying known data compression methods.

The control data 54 may include controller 38 event log data. The event log data may include events derived by the controller 38, events gathered from the gas turbine 12 operations or a combination thereof. For example, the control data 54 may be a listing of the time and types of alarms, alerts, process issues, control events, set point changes etc. that occur in the gas turbine system. In some embodiments, the control data 54 is generated at a second time frame (e.g. less frequently with respect to time than the sensor data 52) and has a second time resolution higher than the first time resolution of the sensor data 52. For example, the controller 38 event log may only store one data point of control data 54 on average per second, per, minute, and so on. The controller 38 event log may store data 54 at irregular intervals, e.g. at the rate that control events occur. In other embodiments, the control data 54 may be generated more or less frequently than one data point per second or minute on average. In the depicted embodiments, the control data 54 may not take up as much memory as the sensor data 52. Therefore, combining the control data 54 with the sensor data 52 may improve predictions and/or alleviate a portion of the transmission (or compression) losses that may be incurred for the sensor data 52.

As further explained below, the analytics center 50 may combine the sensor data 52 and the control data 54 to create the combination model(s) used to derive predictive events for the gas turbine system 12 and the respective accuracies of the predictions. The derived predictive events and accuracies may be communicated to the HMIs 44 of the gas turbine systems 12, where they may be used to direct and/or control operations (e.g. schedule downtime or repairs, operate the gas turbine system 12 at a reduced capacity, etc.) by either the plant operator and/or the controller 38 and/or the predicted events may be recorded in the memory device 40.

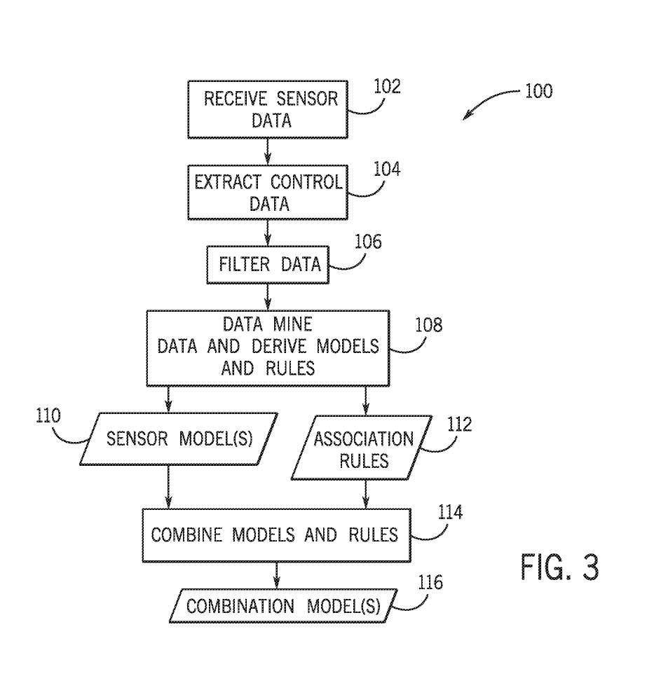

FIG. 3 is a flowchart illustrating an embodiment of a process 100 suitable for deriving or otherwise synthetizing one or more combination models. The combination models may be useful in providing predictive events and may additionally provide for an accuracy probability of the predictive events for a gas turbine system 12. The process 100 may be implemented as computer code or instructions executable by the processor(s) 41 and stored in the memories 45 of the analytics center 50, and/or by the processor(s) 39 and stored in the memories 40 of the controller 38. In the depicted embodiment, the process 100 may receive (block 102) sensor data 52 from a gas turbine system 12. For example, the controller 38 may collect the sensor data 52 from the gas turbine system 12, compress the sensor data 52, and then send the sensor data 52 through a wired communication conduit 51 and/or through a wireless communication conduit 51 to the analytics center 50.

The process 100 may also extract (block 104) the control data 54 from the controller 38 of a gas turbine system 12. As mentioned above, the control data 54 may be a controller event log or a record of events and control actions that occurred and the time at which the events occurred. The control data 54 may have a time resolution that is higher than the time resolution of the compressed sensor data 52. The control data 54 may be extracted (block 104) after, before, or during the time that the sensor data 52 is received (block 102). In the current embodiment, the process 100 creates the combination model(s) using historical data previously received and/or extracted from the gas turbine system 12. The historical data may include both “normal” operations data that does not include any undesired events as well as “undesired event” data that does include undesired events. In other embodiments, the combination models may be created from live data from the gas turbine system 12 or from sets of both historical and live data.

The process 100 may filter (block 106) at least a portion of the data 52, 54. For example, certain sensor data 52 may be undefined, undesired, physically unrealizable, or equal to zero for unreasonable amounts of time. By way of examples, a temperature sensor 42 may occasionally calculate a temperature higher than could be reasonably expected, or controller logs could create duplicate records of alarms when the alarms are not turned off within a threshold period after the alarms initiated. More particularly, filtering techniques and ranges, Boolean operators, and so on, may be used to exclude data 52, 54 which does not meet desired criteria.

The process 100 may then apply certain techniques, such as data mining techniques (block 108) to the filtered sensor data 52 and/or the filtered control data 54 to derive models and rules. In one embodiment, the filtered sensor data 52 and control data 54 may first be combined in to a single set of data and then data mined together. In other embodiments, the sensor data 52 and control data 54 are data mined separately and then combined. Further embodiments data mine the sensor data 52 and the control data 54 before they are combined and then again after they are combined. To data mine the data, the data may first be placed in to a multidimensional database system of the analytics center 50. Then, the data may be analyzed to calculate probabilities from the sensors 42 that certain events have occurred and to find correlations or patterns between the data and the events that follow it.

More particularly, the data mining techniques may include association, classification, clustering, decision tree, outlier detection, evolution analysis, transfer function methods, or a combination thereof. Data mining via association techniques correlates types of data to identify patterns. Data mining via classification techniques groups events with similar attributes together in classifications so they may be more easily identified. Data mining via clustering techniques examines one or more qualities of the data in order to group them based on the qualities, so the groups may be used to identify correlations between data and events. Also, data mining via decision tree techniques utilize multiple layers of criteria to categorize data based on each layer. Additionally, data mining via outlier detection techniques identify data points which stand out or do not comply with the general trend of the remaining data. Further, data mining via evolution analysis describes the trends of data points over time. Moreover, data mining via transfer function methods may analyze data to quantify relationships between the data and the events of interest. For example, a transfer function may transform modeled values into probabilities via a cumulative distribution function of the modeled value's distribution, and then may transform back the probabilities into data values using an inverse of the cumulative distribution function.

From the sensor data 52, the process 100 may create sensor model(s) 110. The sensor models 110 are used to create probability assessments of whether an observed anomaly or undesired event has occurred in the output of at least one sensor 52. The sensor models 110 may include correlations created from statistical techniques such as multivariate Gaussian analysis or z-score analysis. These methods may be implemented in conjunction with certain known data filters to reflect specific operating modes of the turbine system 12. The Gaussian models are created in order to find relevant likelihood of anomaly events being present. Where the sensor models 110 are created by Gaussian analysis, a probability p that an event is more probable than a set significance level φ and will raise a flag may be determined using the following Equations 1-3:

$$\begin{matrix}p ( x ) = {\prod }_{j = 1}^{n} p ( {x}_{j} ; {μ}_{j} ; {σ}_{j}^{2} ) & ( Equation 1 ) \\ p ( x ) = {\prod }_{j = 1}^{n} \frac{1}{\sqrt{2 π} {σ}_{j}} exp ( - \frac{1}{2} \frac{{( {x}_{j} - {μ}_{j} )}^{2}}{{σ}_{j}^{2}} ) & ( Equation 2 ) \\ if ( p ( x ) < φ ) = Raise flag & ( Equation 3 )\end{matrix}$$

Where x is a difference between a sensor reading and a sensor target, μ is the mean of all x values, σ is the standard deviation of all x values. It may be appreciated that the above equations may be used to calculate the probability of a particular sensor data 52 point being anomalous, based on the mean and standard deviation of the known points or points used to train the models, then comparing that probability p to the significance level φ. Significance levels φ vary, but in one embodiment, the significance level φ is on the order of 0.01. When the probability p of a sensor value is less than the significance level φ, the probability of it occurring is significant and the analytics center will raise a flag to mark the point as anomalous so it may be noted in the sensor model 110. Similarly, a z-score z based on the difference x between a sensor 42 reading and a sensor 42 target can be calculated by the well-known z-test. A flag is raised if z is outside an expected range, thus indicating that the sensor 42 value is anomalous and the pattern that led to the sensor 42 value may be noted in a sensor model.

There may be a large number of sensors 42 within each gas turbine system 12, so creating sensor models 110 which relate to certain process conditions and limiting the amount of sensor models 110 for data incoming from sensors 42 which seldom affect the gas turbine system 12 may increase the processing speed at which the analytics center 50 can derive predictive events and turbomachinery issues. A faster processing speed is desired so that predictive events may be communicated as soon as possible to the gas turbine system 12 that may experience them. It is to be noted that the sensor model 110 may include data from a single sensor 42 or from multiple sensors 42.

Patterns found in the mined data via the techniques described earlier may be formalized or used to derive association rules 112. The association rules 112 generally relate patterns in the data to an outcome of the gas turbine system 12. For example, an association rule may recognize a pattern “a” in live sensor data 52 similar to pattern “A” in the mined data. Because the pattern “A” is often followed by an event “B”, the association rule may recognize the event “a” may likely be followed by an event similar to event “B”. The association rules may also recognize variations in patterns like “A” that are more or less likely to be followed by events “B”, and thus provide an accuracy probability of the event “B” occurring. There may be a very large number of association rules 112 created for each gas turbine system 12. The association rules 112 may be trained on historical “normal” data and historical “undesired event” data. Training the association rules 112 may make the rules 112 more accurate and speed up identifying predictive signatures.

The process 100 may then combine (block 114) the sensor models 110 and association rules 112 by logistic regression methods. The logistic regression methods may include, but are not limited to, logistic regressions, logit analysis, linear regression, or any combination thereof. Once combined, the sensor models 110 and association rules 112 may form one or more combination models 116. Each combination model 116 can be used on live or real-time operation data from at least one gas turbine system 12 of a fleet of gas turbine systems 12 to derive a predictive event and additionally to provide an accuracy probability of the predictive event. In some embodiments, the output of the combination model is a score which is then calibrated to raise flags or alerts for further downstream closer analysis to determine the presence and appropriate action.

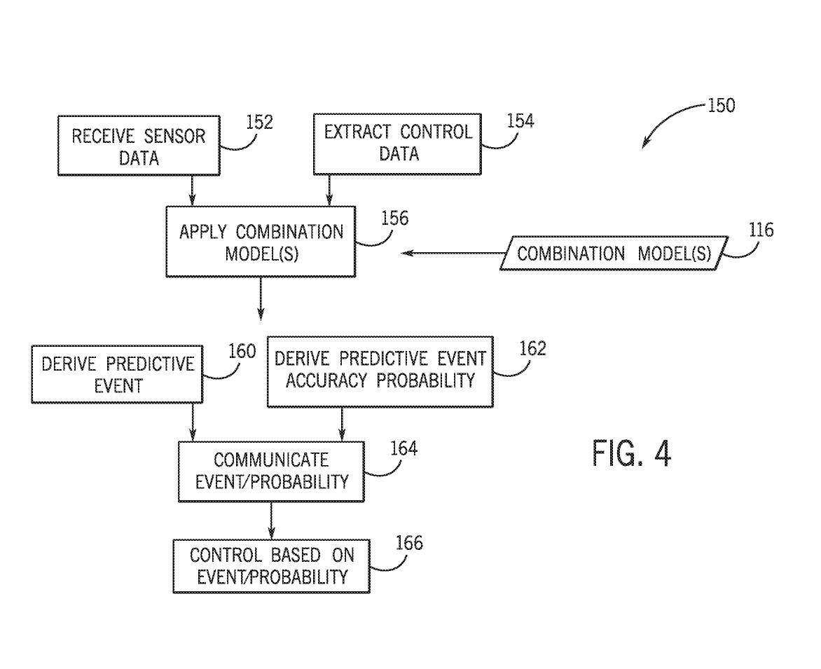

FIG. 4 is a flowchart illustrating an embodiment of a process 150 suitable for utilizing the combination model 116 created in FIG. 3 to provide predictive events and the accuracy probability of the predictive events for a gas turbine system 12, for example in real time. The process 150 may be implemented as computer code or instructions executable by the processor(s) 41 and stored in the memories 45 of the analytics center 50, and/or by the processor(s) 39 and stored in the memories 40 of the controller 38. In one embodiment, the combination model 116 are trained from historical data of the same gas turbine system 12 or similar gas turbine systems 12. In other embodiments, the combination model 116 may be further trained while implemented in the gas turbine system 12. The process 150 may derive the predictive event and the accuracy probability at either a geographically remote or a geographically proximate location.

In the depicted embodiment, the process 150 may receive (block 152) sensor data 52 and extract (block 154) control data 54 from a controller 38 of a gas turbine system 12 or a fleet of gas turbine systems 12 during real time (e.g. from live data), and/or during scheduled times (e.g., every second, minute, and so on). The process 150 may collect the live sensor data 52 and the live control data 54 at the same time. In other embodiments, the data is stored in the local controller 38 and transmitted to the analytics center 50 at regular intervals (e.g. every second, hour, day, week, etc.). The data is combined, mined, and/or filtered according the process 100 of FIG. 3. The process 150 also includes the combination model 116 derived by the process 100 in FIG. 3.

The process 150 may then apply (block 156) the combination model 116 to the operational sensor data 52 and control data 54. In the current embodiment, the combination model 116 then analyzes the data 52, 54 in order to derive (block 160) any predictive events and to derive (block 162) an accuracy probability of the respective predictive events.

The predictive events may include events such as turbomachinery equipment failure, equipment operating below an acceptable efficiency, process values (e.g. temperature, pressure, speeds) shifting outside respective target ranges, as well as other events plant operators may find useful to know about before they occur. In the current embodiment, the combination model 116 also derives (block 162) the accuracy probability of the turbomachinery issues. By way of an example, the method 150 may derive from the live data that there is a 70% chance the IGV 33 will experience an undesired stoppage within the next week. The method 150 may also derive that there is a 50% chance a particular sensor 42 will exceed its target range within the next twenty four hours. A maintenance shutdown twenty two hours from now may then be scheduled to address both issues. Deriving the accuracy probability of each predictive event is a useful factor in scheduling gas turbine system 12 operations, so that the urgency and priorities of each predictive event may be considered.

Further, the method 150 may communicate (block 164) the predictive event and the accuracy probability to the HMI 44 and/or the controller 38 of the gas turbine system 12 to which they relate. The communication may be displayed as alerts on the HMI 44, or as messages electronically sent to plant operators and managers, or as voice alerts read to plant operators, or by any other method that permits the communication to be received by a controller 38 or plant operator at the gas turbine system 12. In one embodiment, the predictive events are not communicated to the HMI 44 and/or the controller 38 unless the accuracy probability is above an accuracy threshold, such as 50% or 70% or a different accuracy probability. In other embodiments, any predictive event related to specified turbomachinery components such as the compressor 20, the combustor 22, and/or the turbine 26 are communicated with their respective accuracy probability regardless of the value of the accuracy probability.

The method may then control (block 166) the gas turbine system 12 based on the predictive event and its accuracy probability. Operations for the gas turbine system 12 may improve if the gas turbine system 12 incorporates control and/or maintenance actions based at least in part on predictive events that may occur in the near future. For example, after receiving the communication or the multiple communications containing predictive events and accuracy probabilities, the plant operators may then schedule downtime in the near future to address multiple issues at the same time. For example, the downtime may be scheduled to preemptively repair or replace both the IGV 33 and sensor 43 if turbomachinery issues related to them with sufficiently high accuracy probabilities are communicated. Control actions may also include changing gas turbine 12 parameters, such as fuel flow, air flow, and so on.

In some embodiments, the analytics center 50 may monitor how long the current combination model(s) 116 has been in place and recommend a re-derivation or optimization after a model lifetime threshold has been reached. The lifetime threshold may be reached after a number of operational hours with a combination model have passed for the gas turbine system 12, such as 50, 300, 500 or a different number of hours. In other embodiments, the lifetime threshold may be reached after the combination model 116 has been in place for a certain time (e.g., number of hours, days, or months, such as 4, 6, 12, or a different number of hours, days, or months). In other embodiments, the analytics center 50 may recommend optimizing the combination model 116 after the average accuracy percentage of each predictive event is below a determined acceptable accuracy target (e.g., 80% accurate, 50% accurate, 40% accurate, etc.) for a threshold accuracy period (e.g. hours, days, or months). By optimizing the combination model 116 occasionally, the analytics center 50 maintains the production of worthwhile predictive events and accuracy probabilities.

Technical effects of the invention include a methodology and system for generating combination models and a methodology and system suitable for deriving predictive events and respective accuracy probabilities for a gas turbine system. In one embodiment, combination model(s) are derived. The model(s) analyze sensor data and control data, create sensor models and association rules, then combine them to create combination model(s) suitable for determining turbomachinery events and probabilities. Because each turbomachinery system is unique, exemplary embodiments generate combination models for each turbomachinery system or fleet of gas turbine systems, and continue to train themselves on real-time operational data. The models may then be used to derive predictive events about turbomachinery issues, among other issues, and their respective accuracy probabilities from live data. The predictions may then be used in order to optimize performance by scheduling process changes or downtimes for component repair and/or replacement.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A turbine system comprising:
a memory configured to store instructions; and
a processor configured to execute the instructions to:
receive a first data comprising sensed operations for one or more turbine systems in a fleet of turbine systems, the sensed operations sensed via a plurality of sensors disposed in the one or more turbine systems;
extract a second data comprising a plurality of events included in a turbine controller event log;
derive at least one sensor model based on the first data;
derive at least one association rule based on the first data, the second data, or a combination thereof; and
derive a combination model by combining the at least one sensor model and the at least one association rule.

2. The system of claim 1, wherein the processor is configured to execute instructions to apply the combination model to derive a predictive event for the one or more turbine systems.

3. The system of claim 2, wherein the processor is configured to execute instructions to apply the combination model to derive an accuracy probability for the predictive event.

4. The system of claim 1, wherein the first data comprises a first time resolution and wherein the second data comprises a second time resolution, and wherein the second time resolution is higher than the first time resolution.

5. The system of claim 1, wherein a predictive event is derived at a geographic location remote to the one or more turbine systems and then communicated to each controller of the one or more turbine systems.

6. The system of claim 1, wherein the predictive event is derived at least in part from real-time operational data collected from the one or more turbine systems.

7. The system of claim 1, wherein the processor is configured to derive the at least one sensor model by executing at least one statistical technique, wherein the at least one statistical technique comprises a multivariate Gaussian analysis, a z-score analysis, or a combination thereof.

8. The system of claim 1, wherein the processor is configured to derive the at least one association rule by data mining techniques, wherein the data mining techniques comprise association, classification, clustering, decision tree, outlier detection, evolution analysis, or a combination thereof.

9. The system of claim 1, wherein the processor is configured to derive the combination model by executing a logistic regression.

10. The system of claim 3, wherein the processor is configured to communicate the predictive event and the accuracy probability for the predictive event only if the accuracy probability is equal to or higher than a threshold accuracy.

11. The system of claim 1, comprising the one or more turbine systems, wherein the one or more turbine system are configured to produce electric power.

12. A method, comprising:
receiving, via a processor, a first data comprising sensed operations for one or more turbine systems in a fleet of turbine systems, the sensed operations sensed via a plurality of sensors disposed in the one or more turbine systems;
extracting, via the processor, a second data comprising a plurality of events included in a turbine controller event log;
deriving, via the processor, at least one sensor model based on the first data;
deriving, via the processor, at least one association rule based on the first data, the second data, or a combination thereof; and
deriving, via the processor, a combination model by combining the at least one sensor model and the at least one association rule.

13. The method of claim 11, comprising executing, via the processor, the combination model to derive a predictive event for the one or more turbine systems and an accuracy probability for the predictive event.

14. The method of claim 11, wherein the at least one sensor model is derived by executing at least one statistical technique, wherein the at least one statistical technique comprises a multivariate Gaussian analysis, a z-score analysis, or a combination thereof.

15. The method of claim 11, wherein the at least one association rule is derived by data mining techniques, wherein the data mining techniques comprise association, classification, clustering, decision tree, outlier detection, evolution analysis, or a combination thereof.

16. A tangible, non-transitory computer-readable media storing computer instructions thereon, the computer instructions, when executed by a processor, cause the processor to:
receive a first data comprising sensed operations for one or more turbine systems in a fleet of turbine systems, the sensed operations sensed via a plurality of sensors disposed in the one or more turbine systems;
extract a second data comprising a plurality of events included in a turbine controller event log;
derive at least one sensor model based on the first data;
derive at least one association rule based on the first data, the second data, or a combination thereof; and
derive a combination model by combining the at least one sensor model and the at least one association rule.

17. The computer-readable media of claim 18, comprising instructions that when executed by the processor cause the processor to apply the combination model to derive a predictive event for the one or more turbine systems and an accuracy probability for the predictive event.

18. The computer-readable media of claim 16, wherein the combination model is derived at a geographic location remote to the one or more turbine systems and then communicated to each controller of the one or more turbine systems.

19. The computer-readable media of claim 16, wherein the predictive event is derived at least in part from real-time operational data collected from the one or more turbine systems.

20. The computer-readable media of claim 19, comprising instructions that when executed by the processor cause the processor to derive the combination model by executing a logistic regression.
